(19) United States
(12) Patent Application Publication
(10) Pub. No.: US 2025/0091304 A1
(43) Pub. Date: Mar. 20, 2025

(54) Gusset Package

(71) Applicant: Sargento Cheese Inc., Plymouth, WI (US)

(72) Inventors: Aaron Strand, Plymouth, WI (US); Megan Goodrich, Neenah, WI (US); James Abston, Plymouth, WI (US)

(21) Appl. No.: 18/369,869

(22) Filed: Sep. 19, 2023

(51) Int. Cl. B29D 22/00; B65B 43/04; B65B 43/10; B65B 51/00; B65B 61/06; B65D 65/38; B65D 75/00

(52) U.S. Cl. CPC B29D 22/003; B65B 43/04; B65B 43/10; B65B 51/00; B65B 61/06; B65D 65/38; B65D 75/008; B65D 2207/00; B65D 2565/385

(57) ABSTRACT

A gusseted package manufactured from recycle ready flexible packaging film including an obround aperture for sealing the front panel and rear panel together to accommodate the stretch characteristics of recycle ready flexible packaging film such that gusseted packages can be manufactured at the same speed and consistency as with non-recycle ready flexible packaging film.

### FIELD OF THE INVENTION

The invention relates to a gusseted package and a method for manufacturing a gusseted package from a web of recycle ready (RR) flexible packaging film.

### BACKGROUND OF THE INVENTION

When producing a gusseted package on a horizontal form, fill and seal (HFFS) machine from non-recycle ready (NRR) flexible packaging film with a sealant layer on one side, it is well-known to fasten the gusset legs at side seals to enhance the stability of the gusseted package. A circular hole is punched in each gusset leg so that when side seal bars seal the front panel to the rear panel, the side seal bars will also seal through the circular holes creating the gusseted package which is capable of standing up. Examples of NRR flexible packaging film commonly used today include a polyester (PET) outer substrate laminated, either via adhesive or via extrusion, to a sealant substrate. The sealant substrate is often a multi-layer material and may be comprised of polyethylene (PE) as a food-contact seal surface with ethylene vinyl alcohol (EVOH) as a common oxygen barrier layer. Since this NRR flexible packaging film is made up of mixed plastics, it is not able to be recovered in any practical recycle stream due to significant differences in polymer melt temperatures.

If the diameter of the circular hole is larger than the width of the side seal, all four of the gusset seals must be hermetic in order for the contents, such as food products, to attain the expected shelf life after being packaged in a modified atmosphere. Since there are four gusset seals (left side of package front and back and right side of package front and back), it is necessary to maintain a close alignment and an even pressure profile during sealing since the sealing is through four layers of film. This is referred to as a narrow operating window. To broaden the operating window, it is a common practice to make a circular hole smaller in diameter than the width of the side seal bar.

For example, commonly the circular hole has a diameter of ⅜″ and side seal bars have a width of ½″. Because the circular hole is smaller in diameter than the width of side seal bars, there remains a 1/16″ width hermetic seal between the edge of the circular hole and the edge of the side seal. Accordingly, if the variance in registration from the location of the circular hole in the multi-substrate film to where the side seals are sealed is less than 1/16″, the gusseted package will be hermetic.

The above example has been successfully used by manufacturers of HFFS machines for NRR flexible packaging film. When switching from NRR to recycle ready (RR) flexible packaging film, there are known problems. Due to the poor dimensional stability of polyethylene films under heat, with polyethylene being the majority comprising resin in a typical RR flexible packaging film, it is difficult to keep the RR flexible packaging film in alignment. The variance in registration from when the circular hole is put into the RR flexible packaging film to when the side seals are sealed can be greater than the distance to the edge of the side seal. For example, if the circular hole has a diameter of ⅜″ and side seal bars have a width of ½″, there is a window of 1/16″ width for a hermetic seal between the edge of the circular hole and the edge of the side seal. However, with the stretch of RR flexible packaging film, it is virtually impossible to stay within the window of 1/16″ thus making it virtually impossible to consistently manufacture gusseted packages that are hermetic.

One solution to more consistently manufacture hermetic gusseted packages is to broaden the window to accommodate the film characteristics. The width of the circular hole can be reduced thus providing a larger window enabling a larger variation in registration while still producing a hermetic gusseted package. For example, if the circular hole has a diameter of ¼″ and side seal bars have a width of ½″, there is a window of ⅛″ width for a hermetic seal between the edge of the circular hole and the edge of the side seal. This enables a larger window for alignment purposes, but it comes at a cost. The cost is a reduction in seal area. In the example above, when the circular hole is reduced from ⅜″ to ¼″, there is 33% reduction in the seal area of the front to rear panels. The reduction in seal area causes the seal to be not strong enough to effectively hold the gusset legs together with liquid or heavier products, decreasing stability, and causing the gusseted pouch to fall over and not be able to remain standing.

More particularly, prior art HFFS machines manufacture gusseted packages from a NRR flexible packaging film. Each gusseted package is made from a web of NRR flexible packaging film supplied on a roll and having at least one side that is heat sealable. During the manufacturing process on the HFFS, there are a series of sequential unit operations that need to occur to properly produce the gusseted package. Web feed rolls pull the web through these unit operations. During each cycle of a HFFS machine, there is a dwell portion when the film is stationary and the unit operations occur, and an index portion, when web feed rolls pull web the width of one package. The following are the sequential unit operations that occur: a punching station punches a hole in web for the rear gusset leg; web feed rolls index the web the width of one gusset package; the punching station punches a hole out of web for the front gusset leg; the web feed rolls index the web the width of one gusset package; the web is folded in a gusset plow station; a gusset sealing station creates the gusset seals; side sealing station creates the side seal; side seal cooling station cools the side seal; and a cutting station cuts the web in the middle of the side seal to create a gusseted package. There are just over a dozen web feed indexes from the first unit operation until the last unit operation. There are approximately six indexes from when the first hole is punched to the gusset plow station, and another six indexes through the gusset scaling station and up to the side sealing station, for a total of about twelve indexes from the first circular hole to the side seal. If the circular hole is to be within the width of the side seal of side seal station, an accurate registration must be maintained during the twelve indexes to keep alignment between circular hole and side seal of side seal station.

It is well known that tension in web occurs when web feed rolls index web through gusset plow station and through all the other unit operations. The more unit operations there are, the higher the web tension. The faster the web feed rolls turn, the higher the web tension. The higher the coefficient of friction (COF) of web, the higher the web tension. With higher web tension comes a higher tendency for web to stretch. It is also well known that the COF of web can vary from one end of roll to the other. The higher the COF, the more stretch. The lower the COF, the less stretch. The higher the variance in COF, the higher the variance in stretch.

All of these challenges are specifically why NRR flexible packaging film has been designed and developed to what it is today; minimizing stretch and fluctuation in stretching caused by web tension and fluctuation in web tension. When switching to a RR flexible packaging film, these developed features are lost, and it becomes virtually impossible to prevent the variance in registration from increasing. It is well known that much lower temperatures are required for sealing RR flexible packaging film. If a lower temperature is used, then additional time is required to make the seals hermetic, but since slowing the HFFS machine down to get the additional seal time is not an option, additional side seal stations need to be added to increase the amount of seal time. These additional unit operations also increase the tension and heat imparted to web, adding even more potential for the variance in registration to increase.

### SUMMARY OF THE INVENTION

In one construction, the disclosure provides a web of recycle ready flexible packaging material used to create a gusseted package comprising a first panel, a second panel; a pair of gusset legs between the first panel and the second panel, each gusset leg having a gusset aperture having a length and a width and wherein the length is greater than the width; a side seal portion having a sealing axis and a gusset seal portion, wherein the gusset aperture is within the side seal portion and is elongate in the direction of the sealing axis.

In another construction, the disclosure provides a method of manufacturing a gusseted package of recycle ready flexible packaging film comprising the steps of providing a web of recycle ready flexible packaging film; creating an obround gusset aperture in each portion of the web that will become a gusset leg; folding the web to create a first panel, a second panel and a pair of the gusset legs therebetween; side sealing the web in a sealing portion along a sealing axis through each gusset aperture, wherein each gusset aperture is elongate in the direction of the sealing axis; gusset sealing the web; and cutting the web through the side seal portion to create individual gusseted packages.

In another construction, the disclosure provides a method of side sealing a web of recycle ready flexible packaging film in the manufacture of a gusseted package comprising the steps of providing a web of recycle ready flexible packaging film that has been folded to create a first panel, a second panel and a pair of the gusset legs therebetween, wherein each gusset leg has an elongate gusset aperture; aligning the elongate apertures on the gusset legs; providing a side sealing portion that contains the first panel, the second panel and the portion of each gusset leg containing the elongate aperture, the sealing portion having a sealing axis and the elongate aperture being elongate in the direction of the sealing axis; and sealing the web in the side sealing portion.

Other aspects of the disclosure will become apparent by consideration of the detailed description and accompanying drawings.

### BRIEF DESCRIPTION OF THE DRAWINGS

FIG. 1 is a perspective view of a HFFS machine to manufacture gusseted packages from recycle ready flexible packaging film.

FIG. 2 is a perspective view of a manufactured gusseted package made from recycle ready flexible packaging film.

FIG. 3 is a front view of a web of recycle ready flexible packaging film during manufacture of a gusseted package on the HFFS machine.

### DETAILED DESCRIPTION OF THE INVENTION

Before any constructions of the disclosure are explained in detail, it is to be understood that the disclosure is not limited in its application to the details of construction and the arrangement of components set forth in the following description or illustrated in the following drawings. The disclosure is capable of other constructions and of being practiced or of being carried out in various ways. For example, although one aspect of the invention is to accommodate the stretch characteristics of recycle ready flexible packaging film such that gusseted packages can be manufactured at the same speed and consistency as with non-recycle ready flexible packaging film, the invention could be used to broaden the operating window on non-recycle ready flexible packaging film such that HFFS speeds and/or manufacturing consistencies might increase.

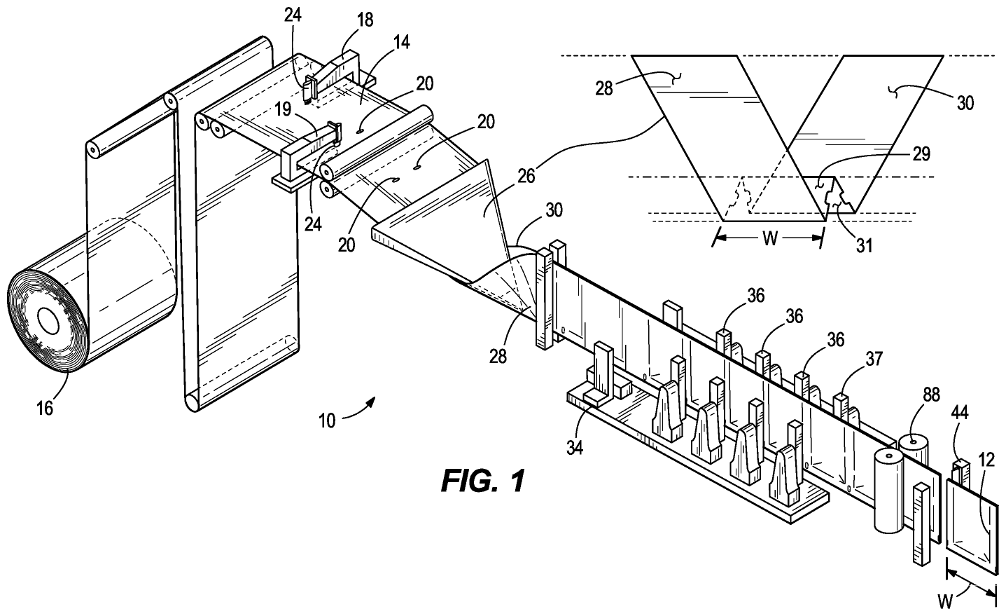

FIG. 1 illustrates an exemplary HFFS machine 10 to manufacture gusseted packages 12 from recycle ready (RR) flexible packaging film. Each gusseted package 12 is made from a web 14 of RR flexible packaging film supplied on a roll 16 and having at least one side that is heat sealable. The RR flexible packaging film is, for example, a majority polyethylene (PE) outer web either adhesive or extrusion laminated to a high barrier, coextruded polyethylene (PE) based sealant available that commercially meets the Association of Plastic Recyclers Polyethylene (PE) Film Critical Guidance. These RR flexible packaging films are becoming more and more readily available commercially from many film manufactures that extrude, print, laminate, slit and rewind to create roll-stock of flexible packaging film for HFFS machines. RR flexible packaging film has the potential of being recovered in existing in-store collection stations, the most common means to collect flexible films in the United States today.

Referring to FIGS. 1-3, the web 14 of RR flexible packaging film is fed from the roll 16 to a punching station 18 and a punching station 19 by web feed rolls 88. The punching stations 18 and 19 create a gusset aperture 20 in each portion of the web 14. The distance between the centers of adjacent apertures 20 will become the width W1 of an individual gusseted package 12. The gusset apertures 20 are formed from punches 24 that are non-circular and elongate in shape. The gusset apertures 20 have a width W2 and a length L2, with the length L2 being greater than the width W2. For example, the gusset apertures 20 can be obround as shown or other shapes such as rectangular.

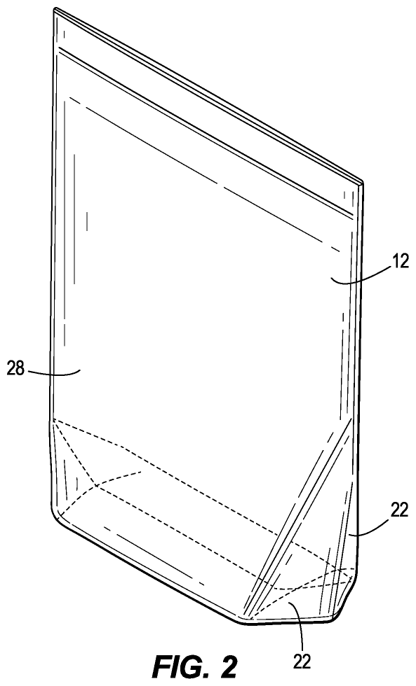

After the punching stations 18 and 19, the web 14 is folded at a plow station 26 to create a front panel 28, a front gusset leg 29, a rear gusset leg 31, and a rear panel 30. Thereafter, the web 14 is moved to a gusset sealing station 34 to create a gusset seal 42 and to three side sealing stations 36 having sealing bars as known in the art to create a side seal 40 having a width W3 and a side seal axis 38. The web 14 is then moved to side seal cooling station 37, and then to a cutting station 44 to individuate the web 14 through each side seal 40 and preferably through the center of what was the gusset apertures 20 to create individual gusseted packages 12 as is shown in FIG. 2.

The gusset aperture 20 enables the HFFS machine 10 to accommodate the stretch characteristics of the RR flexible packaging film such that gusseted packages 12 can be manufactured at the same speed and consistency as with NRR flexible packaging film.

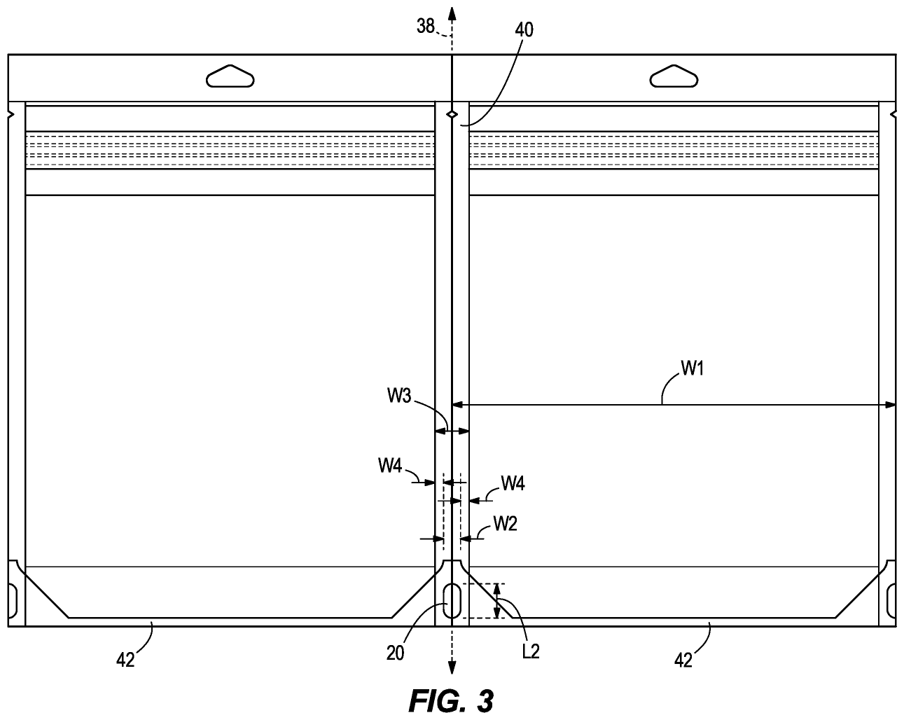

Turning to FIG. 3, each gusset aperture 20 has its length L2 that is elongate in the direction of the side seal axis 38. In one embodiment for example, the side seal width W3 is ½″ and the gusset aperture 20 is obround ¼″×½″ thus allowing a width W4 of ⅛″ on each side of the gusset aperture 20 to the edge of the side seal 40 for variance in registration. With each gusset aperture 20 being ½″ in in length, this regains 33% of seal area as compared to the use of a ¼″ circular aperture. Accordingly, use of the gusset aperture 20 that has a longer length L2 than compared to its width W2 enables a bigger window for registration and enables more sealing area than compared to the prior art circular aperture, and which results in the manufacture of gusseted packages 12 of RR flexible packaging film at the same speed and consistency as with NRR flexible packaging film.

Various features and advantages of the invention are set forth in the following claims.

What is claimed is:

1. A web of recycle ready flexible packaging material used to create a gusseted package comprising:
a first panel;
a second panel;
a pair of gusset legs between the first panel and the second panel, each gusset leg having a gusset aperture having a length and a width and wherein the length is greater than the width;
a side seal portion having a sealing axis; and
a gusset seal portion,
wherein the gusset aperture is within the side seal portion and is elongate in the direction of the sealing axis.

2. The web of recycle ready flexible packaging material of claim 1 wherein the gusset aperture is obround.

3. The web of recycle ready flexible packaging material of claim 1 wherein the gusset aperture is non-circular.

4. The web of recycle ready flexible packaging material of claim 1 wherein the gusset apertures on each gusset leg are aligned.

5. The web of recycle ready flexible packaging material of claim 1 wherein the length of the gusset aperture is at least two times the width of the gusset aperture.

6. A method of manufacturing a gusseted package of recycle ready flexible packaging film comprising the steps:
providing a web of recycle ready flexible packaging film;
creating an obround gusset aperture in each portion of the web that will become a gusset leg;
folding the web to create a first panel, a second panel and a pair of the gusset legs therebetween;
side sealing the web in a sealing portion along a sealing axis through each gusset aperture, wherein each gusset aperture is elongate in the direction of the sealing axis;
gusset sealing the web; and
cutting the web through the side seal portion to create individual gusseted packages.

7. The method of claim 6 wherein the recycle ready flexible packing film is a majority polyethylene outer web with either one of adhesive and extrusion laminated to a high barrier, coextruded polyethylene based sealant.

8. The method of claim 6 wherein a non-recycle ready flexible packaging film is used in place of recycle ready flexible packaging film.

9. The method of claim 6 wherein the gusset apertures on each gusset legs are aligned before the side sealing step.

10. The method of claim 6 wherein the obround gusset has a length and a width and wherein the length is at least two times greater than the width.

11. A method of side sealing a web of recycle ready flexible packaging film in the manufacture of a gusseted package comprising the steps:
providing a web of recycle ready flexible packaging film that has been folded to create a first panel, a second panel and a pair of the gusset legs therebetween, wherein each gusset leg has an elongate gusset aperture;
aligning the elongate apertures on the gusset legs;
providing a side sealing portion that contains the first panel, the second panel and the portion of each gusset leg containing the elongate aperture, the sealing portion having a sealing axis and the elongate aperture being elongate in the direction of the sealing axis; and
sealing the web in the side sealing portion.

12. The method of claim 11 wherein in the sealing step, a seal bar is provided to contact the first panel and a sealing bar is provided to contact the second panel.

13. The method of claim 11 wherein the elongate aperture is obround.

14. The method of claim 11 wherein the elongate aperture has a width and a length and wherein the length is at least two times greater than the width.
